(19) United States
(12) Patent Application Publication
(10) Pub. No.: US 2007/0210133 A1
(43) Pub. Date: Sep. 13, 2007

(54) PORTABLE DRIVER

(76) Inventors: Hiroyuki Oda, Ibaraki (JP); Takashi Ueda, Ibaraki (JP); Yoshihiro Nakano, Ibaraki (JP); Hideyuki Tanimoto, Ibaraki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/683,571

(22) Filed: Mar. 8, 2007

(30) Foreign Application Priority Data
Mar. 9, 2006 (JP) P2006-064685

(51) Int. Cl. B25C 5/02

(52) U.S. Cl. 227/131

(57) ABSTRACT

In a portable driver 1 (portable driver) comprising: a driver plate 18B for driving a nail (fastener) 6; a plunger 18 formed integrally to or separately from the driver plate 18B; a moving unit for linearly moving the plunger 18 in a direction of driving the nail 6; a guiding unit for guiding the linear movement of the plunger by the moving unit, the guiding unit is formed of a linear rail 21 covering a part of the plunger 18. Further, the rail 21 is formed of a hollow member and a slit along the moving direction of the plunger 18 is formed at a part thereof.

### TECHNICAL FIELD

This invention relates to a portable driver for driving a fastener by linearly moving a plunger in a direction of driving the fastener.

### BACKGROUND

### Description of Related-Art

Such a kind of previously known portable driver includes a driver plate for driving a fastener; a plunger formed integrally to or separately from the driver plate; a moving unit for linearly moving the plunger in a direction of driving the fastener; and a guiding unit for guiding the linear movement of the plunger by the moving unit.

Meanwhile, in such a portable driver, there has been proposed the guiding unit using a piston sliding in a cylinder formed at a part of a housing, which guides the linear movement of the plunger. In the configuration using such a guiding unit, the unitfor returning the plunger after the fastener such as a nail has been driven uses the negative pressure generated within the cylinder by the movement of the piston at the time of driving (See JP-A-8-197455).

### SUMMARY

However, the plunger guiding unit using the cylinder and the piston sliding within it presents a problem that it is complicate in structure to increase the size and weight, and particularly, the inner diameter must be precisely set so that the cost will be inevitably increased.

There is also a problem that the energy efficiency is lowered owing to the sliding resistance of the piston. Further, where the unit for returning the plunger to its initial position after the driving uses the negative pressure generated within the cylinder by the movement of the piston at the time of driving, the sealant fit over the outer face of the piston will be worn down owing to the sliding. This leads to a problem of reduction in endurance and deterioration in performance due to great sliding resistance.

This invention has been accomplished in view of the above problems. An object of this invention is to provide a portable driver which can be downsized and weight-reduced by simplifying the structure of a guiding unit and can reduce the production cost and improve the performance.

In order to attain the above object, the invention defined in claim 1 provides a portable driver comprising: a driver plate for driving a fastener; a plunger formed integrally to or separately from the driver plate; a moving unit for linearly moving the plunger in a direction of driving the fastener; and a guiding unit for guiding the linear movement of the plunger by the moving unit, wherein the guiding unit is formed of a linear rail covering a part of the plunger.

The invention defined in claim 2 provides a portable driver according to claim 1, wherein the rail is formed of a hollow member and a slit along the moving direction of the plunger is formed at a part thereof.

The invention defined in claim 3 provides a portable driver according to claim 1 or 2, wherein the rail is manufactured by bending a plate-like member.

The invention defined in claim 4 provides a portable driver according to any one of claims 1 to 3, wherein the rail fits over and holds a length more than 50% of the entire length of the plunger.

In accordance with the invention defined in claim 1, because the guiding unit is formed of only a linear rail covering a part of the plunger, the construction of the guiding unit can be simplified so that the portable driver can downsized and weight-reduced and its assembling capability can be improved. A little gap (the degree not generating rattling in the linear movement of the plunger) is permitted between the rail and the plunger so that high precision is not required in machining the rail and increase in the production cost can be prevented. Further, by restraining the sliding resistance of the plunger, the energy efficiency can be enhanced. As a result, performance improvement and cost reduction in the portable driver can be realized.

In accordance with the invention defined in claim 2, the rail is formed of a hollow member and a slit along the moving direction of the plunger is formed at a part thereof. For this reason, as in the invention defined in claim 3, the rail can be manufactured by bending a plate-like member. For example, the rail can be manufactured easily and at low cost by e.g. press working of a metallic plate using a stamping die.

In accordance with the invention defined in claim 4, a length more than 50% of the entire length of the plunger is fit in and held by the rail, the plunger can be moved straightly with no rattling. Thus, the bending moment is difficult to occur in the driver blade moving together with the plunger. Therefore, the driver blade can be thinned so that it is weight-reduced. Accordingly, the driving efficiency can be enhanced.

### BRIEF DESCRIPTION OF THE DRAWINGS

FIG. 1 is a side sectional view of the electric nail driver (portable driver) according to this invention.

FIG. 2 is an enlarged sectional view taken in line A-A in FIG. 1.

FIG. 3 is a broken front view of a rail of an electric nail driver according to this invention.

FIG. 4 is a view from seen in a arrow E direction in FIG. 3.

FIG. 5 is a planar sectional view of a driving unit (clutch OFF-state) of the electric nail driver according to this invention.

FIG. 6 is a sectional view taken in line B-B in FIG. 5.

FIG. 7 is a planar sectional view of a driving unit (clutch ON-state) of the electric nail driver according to this invention.

FIG. 8 is a sectional view taken in line C-C in FIG. 7.

FIG. 9 is a side view of a coil spring of the electric nail driver according to this invention.

FIG. 10 is a front view of the coil spring of the electric nail driver according to this invention.

FIG. 11 is a broken side view of a flange of the electric nail driver according to this invention.

FIG. 12 is a broken side view of the coil spring inserted in the flange of the electric nail driver according to this invention.

FIG. 13 is a side view of the structure which supports the plunger on the rail according to another format of this invention.

FIG. 14 is an enlarged sectional view taken in line D-D in FIG. 13.

### DESCRIPTION OF THE EMBODIMENTS

Now referring to the attached drawings, an explanation will be given of an embodiment of this invention using, as an example, an electric nail driver which is a form of the portable driver.

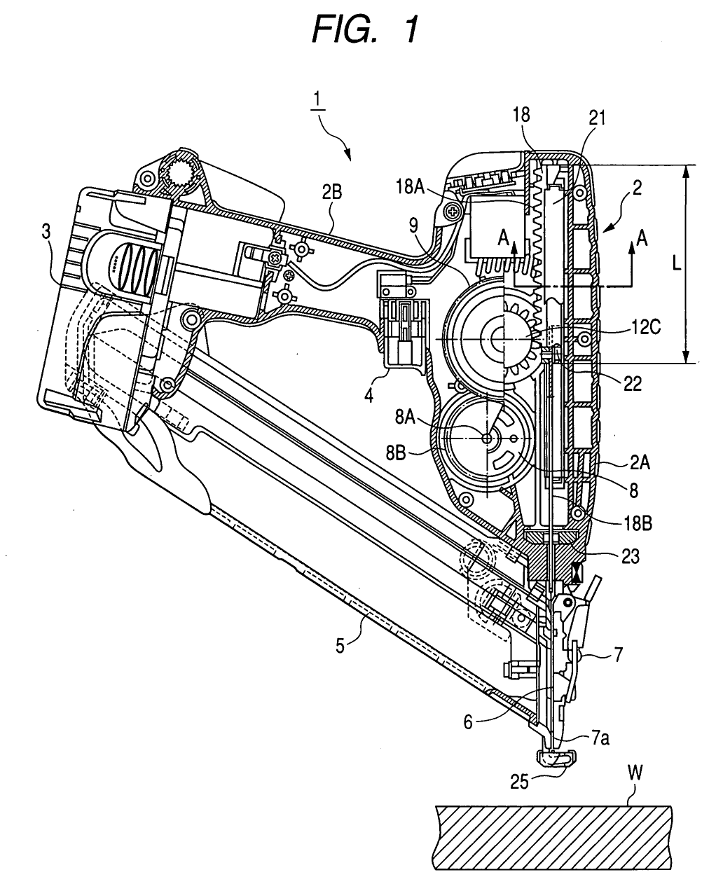

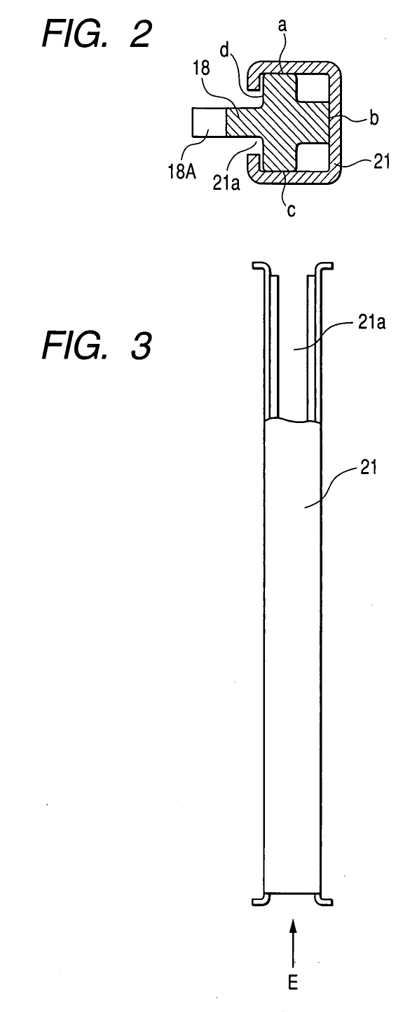

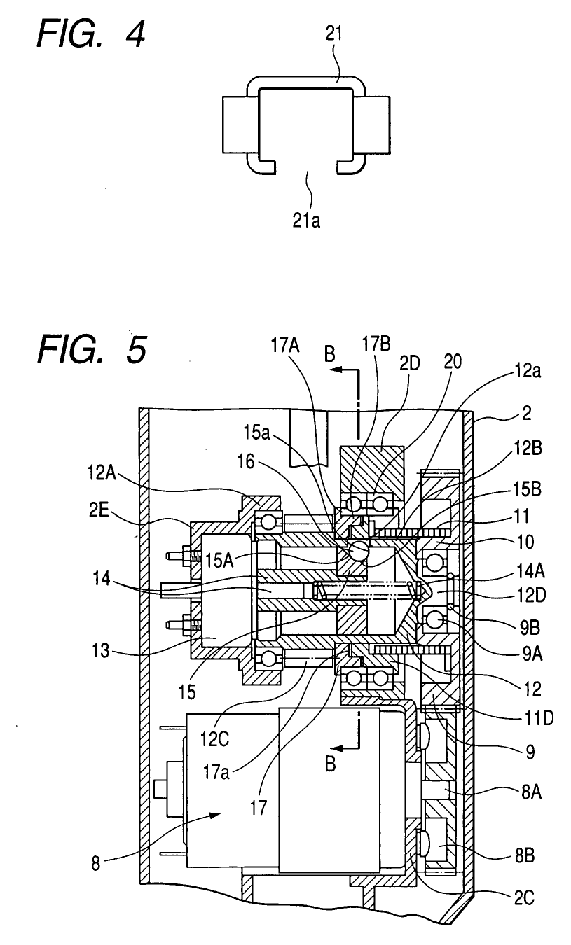

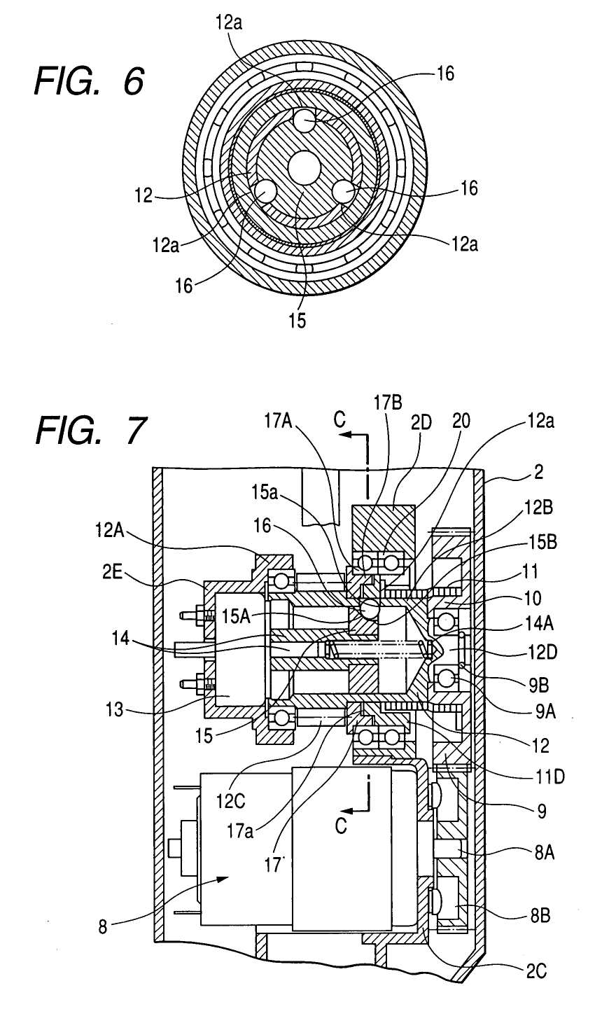

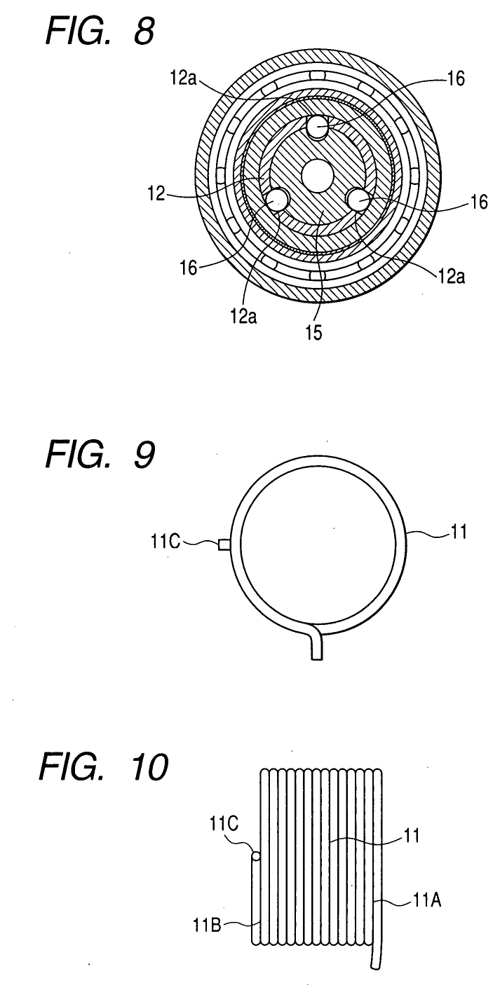

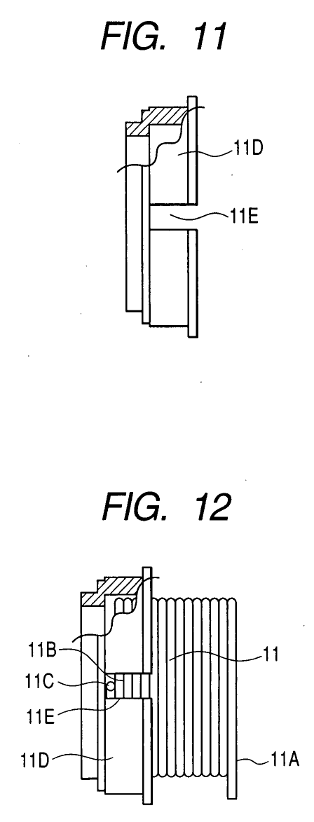

FIG. 1 is a side sectional view of the electric nail driver (portable driver) according to this invention. FIG. 2 is an enlarged sectional view taken in line A-A in FIG. 1. FIG. 3 is a broken front view of a rail. FIG. 4 is a view from seen in an arrow E direction in FIG. 3. FIG. 5 is a planar sectional view of a driving unit (clutch OFF-state) of the electric nail driver. FIG. 6 is a sectional view taken in line B-B in FIG. 5. FIG. 7 is a planar sectional view of a driving unit (clutch ON-state) of the electric nail driver. FIG. 8 is a sectional view taken in line C-C in FIG. 7. FIG. 9 is a side view of a coil spring. FIG. 10 is a front view of the coil spring. FIG. 11 is a broken side view of a flange. FIG. 12 is a broken side view of the coil spring inserted in the flange.

In an electric nail driver 1 shown in FIG. 1, reference numeral 2 denotes a resin housing which is a cover member. The housing 2 is composed of a cylindrical body 2A and a handle 2B connected to the body 2A in a T-shape when viewed from side. At the terminal of the handle 2B of the housing 2 (at the free end opposite to the body 2A), provided is a battery pack 3 for incorporating a battery not shown serving as a power source. In an area of the handle 2B of the housing 2 near to the body 2A thereof, a trigger switch 4 is provided.

Further, as shown in FIG. 1, at the lower end of the housing 2, an injector 7 is provided. To the injector 7, a flat square box-shaped magazine 5 is attached aslant to the body 2A when viewed from side. More concretely, the one end of the magazine 5 is attached to the injector 7 (lower end in FIG. 1) attached to the tip of the body 2A of the housing 2 whereas the other end thereof is attached to the vicinity of the battery pack 3 at the terminal of the handle 2B of the housing 2. In the state shown in FIG. 1, the magazine 5 is inclined aslant upward from the injector 7 attached to the tip of the body 2A of the housing 2 toward the terminal of the handle 2B. Incidentally, although not shown, the magazine 5 incorporates a large number of nails 6 connected stepwise.

Now referring to FIGS. 1 and 5, an explanation will be given of the internal structure of the housing 2.

A motor 8 serving as a driving source is housed in landscape orientation within the body 2A of the housing 2. A gear 8B is fixed to the end of an output shaft (motor shaft) 8A extending from the motor 8 in a direction (direction perpendicular to the paper face in FIG. 1) of the rotating center of the motor 8.

Aside the motor 8 within the body 2A of the housing 2, as seen from FIG. 5, a rotatable driven shaft 12 is arranged in parallel to the output shaft 8A of the motor 8. On the driven shaft 12, a pinion 12C is formed and a flywheel 9 is rotatably supported. The flywheel 9 is tooth-engaged with the gear 8B.

Further, as seen from FIG. 1, within the body 2A of the housing 2, a plunger 18 to be tooth-engaged with the pinion 12C is housed reciprocally linearly movably in a vertical direction in FIG. 1 along a linear rail 21 serving as a guiding unit. At the tip (lower end in FIG. 1) of the plunger 18, a driver plate 18B for extruding a nail 6 is attached by a bolt 22. It should be noted that the plunger 18 is urged in a direction returning to the initial position (upper part in FIG. 1) by a return spring not shown. Further, in this embodiment, the driver plate 18B is formed as a member separated from the plunger 18 and attached to the plunger 18 by the bolt 22. However, the driver plate 18B may be formed integrally to the plunger 18. A damper 23 for receiving redundant energy of the plunger 18 is provided at the bottom of the body 2A of the housing 2.

Now, the rail 21 covers apart of the plunger 18 and serves as a guiding unit for guiding the reciprocal linear movement of the plunger 18. The rail 21, as shown in FIGS. 2 to 4, is formed of a hollow member in a square pipe shape. At a part of the rail 21 (left end face in FIG. 2 opposite to the pinion 12C), a slit (opening) 21a is formed over the entire length along the moving direction (vertical direction in FIGS. 1 and 3) of the plunger 18. Therefore, the rail 21 has a shape which completely covers face a, face b and face c of the plunger 18, and partially covers face d except a rack 18A (see FIG. 2).

As described above, in this embodiment, the rail 21 is formed of a hollow member in a square pipe shape and the slit 21a is formed over the entire length thereof. For this reason, the rail 21 can be manufactured by bending a plate-like member. For example, the rail 21 can be manufactured easily and at low cost by e.g. press working of a metallic plate using a stamping die.

Thus, as shown in FIG. 2, the plunger 18 is fit in the rail 21 with a slight gap therebetween so that its reciprocal linear movement is guided by the rail 21. The plunger 18 is preferably fit in and held by the rail 21 having a length more than 50% of the entire length L thereof (FIG. 1). The portion opposite to the pinion 12C of the plunger 18, as seen from FIG. 2, outwardly protrudes from the slit (opening) 21a of the rail 21. In the protruding portion, as shown in FIG. 1, the rack 18A is formed. The pinion 12c is tooth-engaged with the rack 18A.

Meanwhile, between the flywheel 9 and the driven shaft 12, a clutch mechanism for selectively turning ON/OFF the connection therebetween is provided. Referring to FIGS. 5 to 12, an explanation will be given of the configuration of the clutch mechanism.

As shown in FIG. 5, on the wall 2D of the housing 2, a driven shaft 12 is rotatably supported through a bearing 17A. The driven shaft 12 which is formed in a cylindrical shape is also supported by the wall 2E of the housing 2 through a bearing 12A. In this way, the driven shaft 12 is supported at two points. For this reason, even if force is abruptly applied to the driven shaft 12, it can be rotated stably. Further, the pinion 12C is formed in the region between the outer bearing 12A in the outer periphery of driver shaft 12 and the bearing 17A. Incidentally, the wall 2E also supports a solenoid 13 described later.

Further, as shown in FIG. 5, a nearly-circular driven shaft support 17 is fit in the driven shaft 12. The driven shaft 12 is supported by the bearing 17A through the driven shaft support 17. The driven shaft support 17 has a next end-out segment 17B extending out in the axial direction. With the driven shaft support 17 being fit in the driven shaft 12, a groove 17a is formed between the extend-out segment 17B and the driven shaft 12.

A portion of a flange 11D described later is inserted in the groove 17a between the driven shaft 12 and the extend-out segment 17B. At the positions of the portion inserted in the groove 17a opposite to the flange 11D, three slots 12a are made so as to pass through the inside and outside of the driven shaft 12 (see FIG. 6). In each of the slots 12a, a ball 16 is provided movably in the radial direction. Thus, the movement of the ball 16 is limited in the expansion/contraction direction of a solenoid driver 14 described later and in the circumferential direction of the driven shaft 12 whereas only the movement thereof in the radial direction of the driven shaft 12 is permitted.

In the region on the one end side of the driven shaft 12 and encircled by the wall 2E, a solenoid 13 is arranged. From the solenoid 13, the solenoid driver 14 extends out toward the space within the driven shaft 12. When a current is supplied to the solenoid 13, the solenoid driver 14 extends. In the expansion/contraction direction of the solenoid driver 14 in the space within the driven shaft 12, between the end of the solenoid driver 14 and the driven shaft 12, a solenoid twisting spring 14A is arranged in a contracted state. The solenoid twisting spring 14A urges the solenoid driver 14 in a contraction direction.

Further, at the end of the solenoid driver 14, a cylindrical column-shape urging member 15 is provided. The urging member 15 is rotatable about the axis of the cylindrical column shape. On the outer periphery of the urging member 15, a groove extending in the axial direction is formed. In this groove, a pressing segment 15A having a slope serving as a first urging face and a receiving segment 15B are provided. The slope of the pressing member 15A leaves the center as it approaches the solenoid 13. It should be noted that the outermost diameter of the urging member 15 is set to be slightly smaller than the inner diameter of the space within the driven shaft 12.

Between the pressing segment 15A and receiving segment 15B and the inner face of the internal space of the driven shaft 12, a gap 15a is formed. The receiving segment 15B is formed so that in this gap 15a, the sum of the distance from the receiving segment 15B surface to the inner face of the internal space of the driven shaft 12 and the thickness in the vicinity of the slot 12a of the driven shaft 12 is approximately equal to the diameter of the ball 16.

The movement quantity of the solenoid driver 14 is adjusted so that the receiving segment 15B surface is located at a position opposite to the slot 12a in the most contracted state of the solenoid driver 14 (power interrupting position) and the pressing segment 15A is located at a position opposite to the slot 12a in the most expanded position) of the solenoid driver 14 (power connecting position). Therefore, in the contracted state of the solenoid driver 14, the ball 16 is in contact with the surface of the receiving segment 15B. In this state, the ball 16 does not partially project from the outer surface of the driven shaft 12 via the slot 12a (see FIGS. 5 and 6).

Further, in the expanded state of the solenoid driver 14, the ball 16 is in contact with the pressing segment 15A (see FIG. 8). In this state, a part of the ball 16 partially projects from the outer surface of the driven shaft 12 (see FIGS. 7 and 8). According to the inclination of the body of the electric nail driver 1, the ball 16 may project from the slot 12a owing to gravitation. However, since the ball 16 is not supported by the pressing segment 15A, only slight urging force exists so that the flange 11D described later will not be urged.

Further, as shown in FIG. 5, on the other end side of the driven shaft 12 with respect to the slot 12a, a spring seat 12B is formed. At the tip of the spring seat 12B in parallel to the gear 8B in the longitudinal direction thereof, a supporting shaft 12D is provided. The flywheel 9 is rotatably attached to the supporting shaft 12D through the bearing 9A.

Now, the driven shaft 12 is rotatably supported on the walls 2D and 2E which are a part of the housing 2. Therefore, the flywheel 9 rotatably attached to the supporting shaft 12D which is a part of the driven shaft 12 through the bearing 9A is freely rotatable for the driven shaft 12 and is rotatably supported by the housing 2. Incidentally, at the end of the supporting shaft 12D, a stop ring 9B is attached for preventing the bearing 9A from being removed.

On the outer surface of the flywheel 9, a tooth segment is formed. The tooth segment is tooth-engaged with the gear 8B. Thus, when the gear 8B rotates clockwise, the flywheel 9 rotates counterclockwise. At the position coaxial with the driven shaft 12 of the flywheel 9, a drive shaft 10 is formed integrally thereto.

As seen from FIGS. 9 to 12, at the other end 11B of the coil spring 11, a flange 11D is provided. The flange 11D is a circular member and has a recess 11E at a part of the circle. As regards the flange 11D and the coil spring 11, the other end 11B of the coil spring 11 is coaxially inserted into the flange 11D and a projection 11C which is a tip of a steel wire on the other end 11B of the coil spring 11 is inserted into the recess 11E. For this reason, the flange 11D and the coil spring 11 can be integrally rotated in a rotating direction of the coil spring 11.

As shown in FIG. 5, the one end 11A of the coil spring 11 is secured to the drive shaft 10 and the spring seat 12B of the driven shaft 12 is inserted in the coil spring 11. Further, a bearing 20 is arranged adjacently to and in parallel to the bearing 17A. The flange 11D provided at the other end 11B of the coil spring 11 is rotatably supported by the bearing 20.

Now, it is assumed that when the coil spring 11 is a free state, the internal diameter of the coil spring 11 is approximately equal to the maximum outer diameter of the drive shaft 10 of the flywheel 9. Further, since the outer diameter of the spring seat 12B of the driven shaft 12 is smaller than the maximum outer diameter of the drive shaft 10, in a state where a current is not supplied to the motor 8, the coil spring 11 and driven shaft 12 are in a non-coupled state.

As seen from FIG. 6, where the ball 16 inserted in the slot 12a formed on the driven shaft 12 does not project from the surface of the spring seat 12B, the flange 11D can freely rotate in the groove 17a.

Next, an explanation will be given of the operation of the electric nail driver 1 configured as described above.

While an operator grasps the handle 2B of the housing 2, when he pulls the trigger switch 4 so that it is turned ON, the motor 8 is driven by the power source from the battery accommodated in the battery pack 3. Then, the rotation of the output shaft 8A of the motor 8 is transmitted from the gear 8B to the flywheel 9. Thus, the flywheel 9, its drive shaft 10 and coil spring 11 are rotated at a predetermined speed. When the flywheel 9 is rotated, its angular speed increases so that the rotating energy is accumulated in the flywheel 9. At this time, as seen from FIG. 5, the coil spring 11 is separated from the driven shaft 12 so that the driven shaft 12 does not rotate. Therefore, in this state, no abrasion is generated between the coil spring 11 and the driven shaft 12.

When a predetermined time elapses after the motor 8 starts to rotate, rotating energy necessary to drive the nail 6 is accumulated in the flywheel 9. Where a push-lever 25 has been pressed on a driven target W, the driver circuit not shown is actuated so that the solenoid 13 is energized. Thus, the solenoid driver 14 extends against the urging force of the solenoid twisting spring 14A. At this time, within the gap 15a, the face of the ball 16 in contact with the urging member 15 changes from the receiving segment 15B surface to the pressing segment 15A. The pressing segment 15A is formed of the slope and the ball 16 cannot move in the extension/contraction direction of the solenoid driver 14. Therefore, when the solenoid driver 14 extends, by the pressing segment 15A, the ball 16 is moved outwardly in the radial direction of the driven shaft 12. Thus, as seen from FIGS. 7 and 8, the ball 16 projects from the outer surface of the driven shaft 12.

As seen from FIGS. 7 and 8, when the three balls 16 are projected from the surface of the spring seat 12B, respectively, by the pressing segment 15A, the flange 11D is extended outwardly in the radial direction by these three balls 16 so that friction force is generated between the balls 16 and the flange 11D. As a result, as seen from FIG. 7, the inter diameter of the coil spring 11 is reduced so that the friction force between the coil spring 11 and the driven shaft 12 is increased. After several tens seconds, the coil spring 11 is fastened to the driven shaft 12 so that the driven shaft 12 rotates together with the coil spring 11 and drive shaft 10.

Further, the urging member 15 is rotatably attached to the solenoid driver 14 and coupled with the driven shaft 12 through the balls 16. Therefore, the urging member 15 is rotated together with the driven shaft 12. Now, the driven shaft 12 has the pinion 12C tooth-engaged with the rack 18A of the plunger 18. So, when the driven shaft 12 rotates, the plunger 18 moves toward the tip side of the housing 2.

When the driven shaft 12 is rotated, the rotating energy accumulated in the flywheel 9 as well as the output from the motor 8 is transmitted to the driven shaft 12. For this reason, the driven shaft 12 is rotated abruptly at a high speed in a state coupled with the coil spring 11. Incidentally, simultaneously when the solenoid 13 is driven, power supply to the motor 8 may be stopped. According to the abrupt high speed rotation of the driven shaft 12, the plunger 18 also moves abruptly toward the tip of the housing 2. The driver blade 18B attached to the tip of the plunger 18 is extruded in the same direction so that the tip of the driver blade 18B collides with the nail 6 accommodated in the injector 7. As a result, by this collision force, the nail 6 is extruded from the injection mouth 7a of the injector 7 is driven into the driven target W such as wood.

According to the inclination of the body of the electric nail driver 1, the balls 16 may project from the slots 12a owing to gravitation. However, since the balls 16 are not supported by the pressing segment 15A, only slight urging force exists so that the flange 11D will not be urged.

When the driving has been completed, energization of the solenoid 13 is completed. So, the solenoid driver 14 moves in the contracting direction by the urging force of the solenoid twisting spring 14A. Since the urging member 15 also moves likewise, the balls 16 are seated on the receiving segment 15B surface. Correspondingly, the friction force between the balls 16 and the flange 11D attached to 11B, the other end of the coil spring 11, is lost. Then, the coil spring 11 is loosened at the area having tightened the spring seat 12B and restored to the internal diameter before the driving is started. Thus, the coupling between the coil spring 11 and the driven shaft 12 is released.

If the coupling of the driven shaft 12 with the coil spring 11 is released after the nail 6 has been driven into the driven target W, the force urging the plunger 18 toward the tip thereof does not act on the plunger 18. Thus, the plunger 18 is pulled back toward the rear end (upper end in FIG. 1) by a return spring (not shown) and restored to the state before the nail 6 is driven in.

Accordingly, by repeating the operation described above, the nail 6 can be successively driven into the driven target such as wood. Incidentally, after the push lever 25 is previously pressed on the driven target W, the trigger switch 4 may be turned ON (pulled).

In the operation described above, in the electric nail driver 1 according to this embodiment, since the guiding unit for guiding the linear movement of the plunger 18 is formed of only the linear rail 21, the construction of the guiding unit can be simplified so that the electric nail driver 1 can downsized and weight-reduced and its assembling capability can be improved.

Further, a little gap (the degree not generating rattling in the linear movement of the plunger 18) is permitted between the rail 21 and the plunger 18 so that high precision is not required in machining the rail 21 and an increase in the production cost can be prevented. Further, by restraining the sliding resistance of the plunger 18, the energy efficiency can be enhanced. As a result, performance improvement and cost reduction in the electric nail driver 1 can be realized.

In this embodiment, the rail 21 is formed of a hollow member and the slit 21a is formed at a part thereof. For this reason, the rail 21 can be manufactured by bending a plate-like member. For example, the rail 21 can be manufactured easily and at low cost by e.g. press working of a metallic plate using a stamping die.

In this embodiment, since a length more than 50% of the entire length of the plunger 18 is fit in and held by the rail 21, the plunger 18 can be moved straightly with no rattling. Thus, the bending moment is difficult to occur in the driver blade 18B moving together with the plunger. Therefore, the driver blade 18B can be thinned so that it is weight-reduced. Accordingly, the driving efficiency can be enhanced.

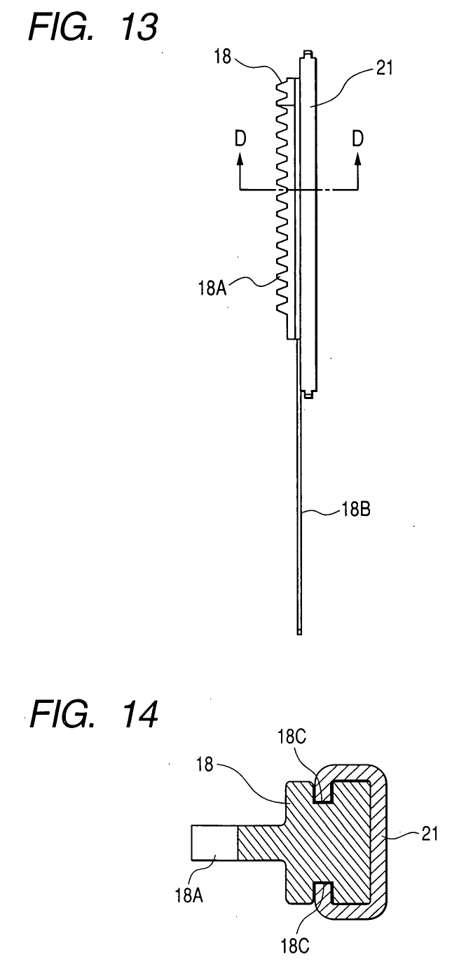

Another format of this invention is shown in FIGS. 13 and 14.

FIG. 13 is a side view of the structure which supports the plunger on the rail according to this format of this invention. FIG. 14 is an enlarged sectional view taken in line D-D in FIG. 13. As shown, by forming linear guide grooves 18C on both sides of the plunger 18 in the longitudinal direction thereof (direction perpendicular to paper face in FIG. 14) and engaging the opened end edges of the rail 21 in the these guide grooves 18C, the linear movement of the plunger 18 maybe guided by the rail 21.

In this format also, since the guiding unit for guiding the linear movement of the plunger 18 is formed of only the linear rail 21 so that the sides of the plunger 18 are guided, the rail 21 can be downsized and weight-reduced.

In the above embodiments, as an example of the portable driver, the electric nail driver has been explained. However, this invention can be applied to any other portable driver for driving a screw or a staple other than the nail serving as a fastener.

What is claimed is:

1. A portable driver comprising:
a driver plate for driving a fastener;
a plunger formed integrally to or separately from said driver plate;
a moving unit for linearly moving said plunger in a direction of driving the fastener; and
a guiding unit for guiding the linear movement of said plunger by said moving unit, wherein
said guiding unit is formed of a linear rail covering a part of said plunger.

2. A portable driver according to claim 1, wherein said rail is formed of a hollow member and a slit along the moving direction of said plunger is formed at a part thereof.

3. A portable driver according to claim 1, wherein said rail is manufactured by bending a plate-like member.

4. A portable driver according to claim 1, wherein said rail fits over and holds a length more than 50% of the entire length of said plunger.
